(19) United States
(12) Patent Application Publication
(10) Pub. No.: US 2026/0311950 A1
(43) Pub. Date: Oct. 8, 2026

(54) DISCHARGE TUBE

(71) Applicant: HAMAMATSU PHOTONICS K.K., Hamamatsu-shi, Shizuoka (JP)

(72) Inventor: Hiroyuki KAGEYAMA, Shizuoka (JP)

(73) Assignee: HAMAMATSU PHOTONICS K.K., Hamamatsu-shi, Shizuoka (JP)

(21) Appl. No.: 19/482,052

(22) PCT Filed: Dec. 28, 2023
(86) PCT No.: PCT/JP2023/047335

§ 371 Date: Nov. 6, 2025

(30) Foreign Application Priority Data
May 10, 2023 (JP) 2023-078046

(51) Int. Cl. H01J 17/06; H01J 17/10

(52) U.S. Cl. CPC H01J 17/06; H01J 17/10

(57) ABSTRACT

A discharge tube includes a container; an anode portion; a cathode portion having a plate shape that emits photoelectrons in response to an an anode electrode portion extending along a facing direction in which the anode portion and the cathode portion face each other; and a cathode electrode portion extending along the facing direction. When a side on which the anode portion is located with respect to the cathode portion in the facing direction is defined as one side, and a side opposite the one side is defined as the other side, the anode electrode portion extends from the anode portion to the other side, and the cathode electrode portion extends from the cathode portion to the other side. A joint region of the cathode portion with the cathode electrode portion is exposed from the anode portion when viewed from the one side in the facing direction.

### TECHNICAL FIELD

The present disclosure relates to a discharge tube.

### BACKGROUND ART

Patent Literature 1 describes a discharge tube for detecting ultraviolet rays that includes an anode portion, a cathode portion, and a plurality of lead wires connected to each of the anode portion and the cathode portion. When the discharge tube described in Patent Literature 1 is manufactured, the cathode portion is welded to the lead wires, and then a spacer is disposed between the cathode portion and the anode portion. Thereafter, the anode portion is welded to the lead wires, and the spacer is removed.

### CITATION LIST

### Patent Literature

Patent Literature 1: Japanese Unexamined Patent Publication No. 2012-207971

### SUMMARY OF INVENTION

### Technical Problem

In the discharge tube described above, simplification of the manufacturing process is required. In addition, both the suppression of the occurrence of unintended discharge (abnormal discharge) and an improvement in detection accuracy are required.

Therefore, one aspect of the present disclosure provides a discharge tube capable of simplifying the manufacturing process of the discharge tube and improving the detection accuracy.

### Solution to Problem

A discharge tube according to one aspect of the present disclosure is [1] “a discharge tube including: a container in which a discharge gas is sealed; an anode portion made of a plate-shaped member in which an opening is formed, and disposed in the container; a cathode portion made of a plate-shaped member, disposed in the container to face the anode portion, and emitting photoelectrons in response to an incidence of light that has passed through the opening; an anode electrode portion having a rod shape, extending along a facing direction in which the anode portion and the cathode portion face each other, and joined to the anode portion; and a cathode electrode portion having a rod shape, extending along the facing direction, and joined to the cathode portion. When a side on which the anode portion is located with respect to the cathode portion in the facing direction in which the anode portion and the cathode portion face each other is defined as one side, and a side opposite the one side is defined as the other side, the anode electrode portion extends from the anode portion to the other side, and the cathode electrode portion extends from the cathode portion to the other side. A joint region of the cathode portion with the cathode electrode portion is exposed from the anode portion when viewed from the one side in the facing direction”.

In the discharge tube, the joint region of the cathode portion with the cathode electrode portion is exposed from the anode portion when viewed from the one side in the facing direction. Accordingly, both the joint region of the cathode portion with the cathode electrode portion and a joint region of the anode portion with the anode electrode portion are visible from the one side in the facing direction. Therefore, when the discharge tube is manufactured, for example, the cathode portion is positioned with respect to the cathode electrode portion and the anode portion is positioned with respect to the anode electrode portion, and then the joining of the cathode portion to the cathode electrode portion and the joining of the anode portion to the anode electrode portion can be performed in a single process. As a result, the manufacturing process can be simplified compared to when the cathode portion is joined to the cathode electrode portion, then the anode portion is positioned with respect to the anode electrode portion, and then the anode portion is joined to the anode electrode portion as in the manufacturing method described in Patent Literature 1 described above. In addition, in the discharge tube, since the joint region of the cathode portion with the cathode electrode portion does not overlap the anode portion in the facing direction, the occurrence of abnormal discharge due to the joint region overlapping the anode portion can be suppressed. Therefore, according to the discharge tube, the manufacturing process of the discharge tube can be simplified, and the detection accuracy can be improved.

A discharge tube according to one aspect of the present disclosure may be [2] “the discharge tube according to [1], in which the joint region is formed to be thinner than a portion of the cathode portion, the portion surrounding the joint region”. In this case, the joining of the cathode portion to the cathode electrode portion can be facilitated.

A discharge tube according to one aspect of the present disclosure may be [3] “the discharge tube according to [2], in which the joint region is formed to be thinner than the portion surrounding the joint region by forming a recess in the cathode portion, the recess being open to the one side”. In this case, for example, the recess can be used as a mark, and the joining of the cathode portion to the cathode electrode portion can be facilitated.

A discharge tube according to one aspect of the present disclosure may be [4] “the discharge tube according to any one of [1] to in which the cathode portion includes a cutout portion formed in an outer edge portion, and the cutout portion is exposed from the anode portion when viewed from the one side in the facing direction”. In this case, the occurrence of abnormal discharge due to the cutout portion overlapping the anode portion can be suppressed.

A discharge tube according to one aspect of the present disclosure may be [5] “the discharge tube according to [4] in which the cathode portion further includes a protruding portion protruding from an inner surface of the cutout portion, and the protruding portion is located inside the cutout portion when viewed in the facing direction”. In this case, the occurrence of abnormal discharge due to the protruding portion protruding from the cutout portion can be suppressed.

Advantageous Effects of Invention According to one aspect of the present disclosure, it is possible to provide the discharge tube capable of simplifying the manufacturing process of the discharge tube and improving the detection accuracy.

### BRIEF DESCRIPTION OF DRAWINGS

FIG. 1 is a perspective view of a discharge tube according to an embodiment.

FIG. 2 is a plan view of the discharge tube.

FIG. 3 is a plan view of a discharge tube of a first modification example.

FIG. 4 is a perspective view of a discharge tube of a second modification example.

### DESCRIPTION OF EMBODIMENTS

Hereinafter, one embodiment of the present disclosure will be described in detail with reference to the drawings. Incidentally, in the following description, the same reference signs are used for the same or corresponding components, and duplicate descriptions will be omitted.

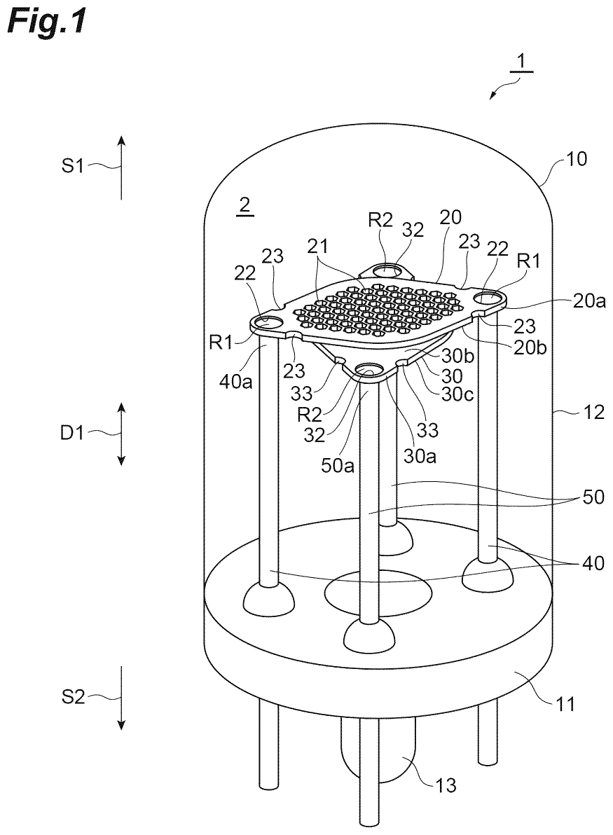

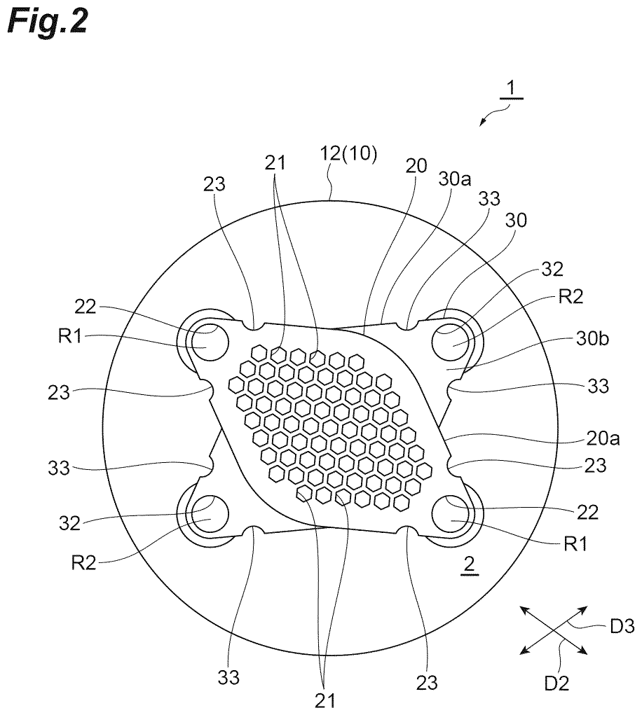

As shown in FIGS. 1 and 2, a discharge tube 1 includes a container 10, an anode portion 20, a cathode portion 30, a pair of anode electrode portions 40, and a pair of cathode electrode portions 50. The anode portion 20 and the cathode portion 30 are disposed in the container 10 to face each other. Hereinafter, a direction (facing direction) in which the anode portion 20 and the cathode portion 30 face each other is defined as a direction D1, a side on which the anode portion 20 is located with respect to the cathode portion 30 in the direction D1 is defined as one side S1 (an upper side in FIG. 1), and a side on which the cathode portion 30 is located with respect to the anode portion 20 in the direction D1 is defined as the other side S2 (a lower side in FIG. 1). The discharge tube 1 is a sensor that detects ultraviolet rays by utilizing the characteristics associated with the work function of the cathode portion 30. The discharge tube 1 is used, for example, in applications such as flame detection, combustion monitoring, discharge detection, and a safety device for hydrogen or ammonia combustion.

The container 10 includes a stem 11 and a glass bulb 12. The stem 11 is formed, for example, in an annular disk shape. An exhaust tube 13 is connected to a central portion of the stem 11. The glass bulb 12 is formed, for example, in a substantially cylindrical shape with an end portion (top portion) on the one side S1 in the direction D1 closed, and is joined to an outer edge portion of the stem 11 at an end portion (bottom portion) on the other side S2 in the direction D1. Accordingly, the inside of the container 10 is sealed in an airtight manner. A discharge gas 2 is sealed in the container 10. The glass bulb 12 is made of, for example, a material that is transmissive to ultraviolet rays. Examples of the material of the glass bulb 12 include borosilicate glass, ultraviolet-transmitting glass, quartz glass, and crystalline materials such as MgF₂.

The anode portion 20 is formed in a flat plate shape from a metal material. The anode portion 20 is formed, for example, in a substantially rhombus shape when viewed in the direction D1. In this example, the anode portion 20 is formed in a substantially rhombus shape with one diagonal longer than the other diagonal, and the longer diagonal is aligned along a direction D2 in which the pair of anode electrode portions 40 face each other. Each corner portion of the anode portion 20 in a plan view is curved not to have a sharp top portion. The anode portion 20 is made of, for example, tungsten, nickel, molybdenum, copper, stainless steel, Kovar metal, or the like.

A plurality of openings 21 (through-holes) penetrating through the anode portion 20 along the direction D1 are formed in a central portion of the anode portion 20. Each of the openings 21 is formed, for example, in a hexagonal shape. The plurality of openings 21 are regularly disposed side by side in a two dimensional pattern at regular spacing. In other words, the anode portion 20 includes, in the central portion thereof, a substantially rhombus-shaped mesh portion formed by the plurality of openings 21 provided along an outer edge portion 20a of the anode portion 20, and includes, in the outer edge portion thereof, a frame portion that surrounds the mesh portion. Incidentally, the shape of the openings 21 may be a polygonal shape or a circular shape other than a hexagonal shape, and the disposition, size, number, and the like of the openings 21 can also be selected in various forms depending on the application.

A recess 22 is formed at each end portion of the anode portion 20 in the direction D2. In this example, the recesses 22 are open to the one side S1 in the direction D1, and are formed in a circular shape when viewed in the direction D1. The recesses 22 are formed, for example, by half-etching, and are formed to be thinner than portions of the anode portion 20 that surround the recesses 22. Incidentally, in the present embodiment, since the plate material constituting the anode portion 20 has a uniform thickness, the recesses 22 are formed to be thinner than portions of the anode portion 20 other than the recesses 22 (excluding the openings 21). As will be described later, the anode portion 20 is joined to the anode electrode portions 40 on the other side S2 in the direction D1 at the positions of the recesses 22. Namely, each of the recesses 22 constitutes a joint region R1 with the anode electrode portion 40.

A plurality of (four in this example) cutout portions 23 are formed in the outer edge portion 20a of the anode portion 20. The cutout portions 23 are portions at which, for example, when the anode portion 20 is formed in a metal member having a plate shape by etching or the like during the manufacturing process of the anode portion 20, bridge portions that connect the anode portion 20 and the metal member that surrounds the anode portion 20 are formed. Namely, each of the cutout portions 23 is a configuration necessary for manufacturing, and does not have any function as an electrode. Furthermore, in the present embodiment, no bridge portion remains in the anode portion 20. When viewed in the direction D1, two cutout portions 23 are disposed on both sides of one recess 22 in a direction perpendicular to the direction D2 to face each other. When viewed in the direction D1, the remaining two cutout portions 23 are disposed on both sides of the other recess 22 in the direction perpendicular to the direction D2 to face each other. Each of the cutout portions 23 is formed, for example, in a semicircular shape when viewed in the direction D1.

The cathode portion 30 is formed in a flat plate shape from a metal material. In this example, the cathode portion 30 has the same shape as the anode portion 20. Namely, the cathode portion 30 is formed in a substantially rhombus shape when viewed in the direction D1. The cathode portion 30 is formed in a substantially rhombus shape with one diagonal longer than the other diagonal, and the longer diagonal is aligned along a direction D3 in which the pair of cathode electrode portions 50 face each other. Each corner portion of the cathode portion 30 in a plan view is curved not to have a sharp top portion. The cathode portion 30 is made of, for example, tungsten, nickel, molybdenum, copper, Kovar metal, or the like.

Unlike the anode portion 20, no opening is formed in the cathode portion 30. In the discharge tube 1, light that has passed through the openings 21 of the anode portion 20 is incident on a surface 30b of the cathode portion 30. The surface 30b is a surface (flat surface) of the cathode portion 30 on the one side S1 in the direction D1, and functions as a photoelectric surface. The surface 30b emits photoelectrons in response to the incidence of light that has passed through the openings 21.

A recess 32 is formed at each end portion of the cathode portion 30 in the direction D3. In this example, the recesses 32 are open to the one side S1 in the direction D1, and are formed in a circular shape when viewed in the direction D1. The recesses 32 are formed, for example, by half-etching, and are formed to be thinner than portions of the cathode portion 30 that surround the recesses 32. Incidentally, in the present embodiment, since the plate material constituting the cathode portion 30 has a uniform thickness, the recesses 32 are formed to be thinner than portions of the cathode portion 30 other than the recesses 32. As will be described later, the cathode portion 30 is joined to the cathode electrode portions 50 on the other side S2 in the direction D1 at the positions of the recesses 32. Namely, each of the recesses 32 constitutes a joint region R2 with the cathode electrode portion 50.

A plurality of (four in this example) cutout portions 33 are formed in an outer edge portion 30a of the cathode portion 30. Incidentally, since the cutout portions 33 have the same configuration as the cutout portions 23, the description thereof will be omitted here. When viewed in the direction D1, two cutout portions 33 are disposed on both sides of one recess 32 in a direction perpendicular to the direction D2 to face each other. When viewed in the direction D1, the remaining two cutout portions 33 are disposed on both sides of the other recess 32 in the direction perpendicular to the direction D2 to face each other. Each of the cutout portions 33 is formed, for example, in a semicircular shape when viewed in the direction D1.

The anode electrode portions 40 are rod-shaped electrode pins (stem pins), are provided to penetrate through the stem 11, and are fixed to the stem 11. The anode electrode portions 40 extend straight from the stem 11 along the direction D1. When viewed in the direction D1, the pair of anode electrode portions 40 are disposed to face each other in the direction D2 with the central portion of the stem 11 interposed therebetween. The anode electrode portions 40 are made of, for example, Kovar metal.

Each of the anode electrode portions 40 is joined to the joint region R1 of the anode portion 20 at an end portion 40a on the one side S1 in the direction D1, and extends from the anode portion 20 to the other side S2 in the direction D1. More specifically, the end portion 40a is joined to a portion of a surface 20b of the anode portion 20 on the other side S2 in the direction D1, the portion overlapping the recess 22 in the direction D1. In this example, the anode electrode portions 40 are joined to the anode portion 20 by laser welding.

During welding, the anode portion 20 is joined to each of the anode electrode portions 40, for example, by irradiating the recess 22 with laser light from the one side S1 in the direction D1 in a state in which the end portion 40a is brought into contact with the anode portion 20 on the other side S2 of the recess 22, and melting and solidifying at least one of the anode portion 20 and the anode electrode portion 40 at the recess 22. The pair of anode electrode portions 40 have the same height, and the anode portion 20 is held perpendicular to the direction D1 by the pair of anode electrode portions 40. Namely, the anode electrode portions 40 function as holding members that hold the anode portion 20.

The cathode electrode portions 50 are rod-shaped electrode pins (stem pins), are provided to penetrate through the stem 11, and are fixed to the stem 11. The cathode electrode portions 50 extend straight from the stem 11 along the direction D1. When viewed in the direction D1, the pair of cathode electrode portions 50 are disposed to face each other in the direction D3 with the central portion of the stem 11 interposed therebetween. The cathode electrode portions 50 are made of, for example, Kovar metal.

Each of the cathode electrode portions 50 is joined to the joint region R2 of the cathode portion 30 at an end portion 50a on the one side S1 in the direction D1, and extends from the cathode portion 30 to the other side S2 in the direction D1. More specifically, the end portion 50a is joined to a portion of a surface 30c of the cathode portion 30 on the other side S2 in the direction D1, the portion overlapping the recess 32 in the direction D1. In this example, the cathode electrode portions 50 are joined to the cathode portion 30 by laser welding.

During welding, the cathode portion 30 is joined to each of the cathode electrode portions 50, for example, by irradiating the recess 32 with laser light from the one side S1 in the direction D1 in a state in which the end portion 50a is brought into contact with the cathode portion 30 on the other side S2 of the recess 32, and melting and solidifying at least one of the cathode portion 30 and the cathode electrode portion 50 at the recess 32. The pair of cathode electrode portions 50 have the same height, and the cathode portion 30 is held perpendicular to the direction D1 and parallel to the anode portion 20 by the pair of cathode electrode portions 50. Namely, the cathode electrode portions 50 function as holding members that hold the cathode portion 30. Incidentally, as described above, the anode portion 20 is disposed on the one side S1 in the direction DI with respect to the cathode portion 30. Therefore, the height of the pair of anode electrode portions 40 is set to be higher than the height of the pair of cathode electrode portions 50.

In the discharge tube 1, the joint regions R2 of the cathode portion 30 with the cathode electrode portions 50 are exposed from the anode portion 20 when viewed from the one side S1 in the direction D1. Namely, the anode portion 20 is not disposed on the one side S1 of the joint regions R2, and the joint regions R2 do not overlap the anode portion 20 in the direction D1. In addition, when viewed from the one side S1 in the direction D1, the cutout portions 23 of the anode portion 20 are exposed from the cathode portion 30, and the cutout portions 33 of the cathode portion 30 are exposed from the anode portion 20.

The operation of the discharge tube 1 will be described. In the usage state, a voltage is applied between the anode portion 20 and the cathode portion 30 via the anode electrode portions 40 and the cathode electrode portions 50. In the usage state, when ultraviolet light is incident on the cathode portion 30 (surface 30b) through the container 10 (glass bulb 12) and the openings 21 of the anode portion 20, photoelectrons are emitted from the cathode portion 30. The photoelectrons are attracted to the anode portion 20, and collide with discharge gas molecules in the container 10, thereby ionizing the discharge gas molecules. Of electrons and positive ions generated by the ionization, the electrons repeatedly collide with and ionize other discharge gas molecules, and reach the anode portion 20. Meanwhile, the positive ions are accelerated toward the cathode portion 30, and collide with the cathode portion 30, thereby generating a large number of secondary electrons. The repetition of the above phenomenon causes a current to flow between the anode portion 20 and the cathode portion 30, thereby resulting in a discharge state. In the discharge tube 1, this discharge phenomenon is utilized to detect light in the ultraviolet region.

### Functions and Effects

In the discharge tube 1, the joint regions R2 of the cathode portion 30 with the cathode electrode portions 50 are exposed from the anode portion 20 when viewed from the one side S1 in the direction D1 (facing direction). Accordingly, both the joint regions R2 of the cathode portion 30 with the cathode electrode portions 50 and the joint regions R1 of the anode portion 20 with the anode electrode portions 40 are visible from the one side S1 in the direction D1. Therefore, when the discharge tube 1 is manufactured, for example, by positioning the cathode portion 30 with respect to the cathode electrode portions 50 and positioning the anode portion 20 with respect to the anode electrode portions 40, and then performing irradiation with laser light for laser welding from the one side S1 in the direction D1, the joining of the cathode portion 30 to the cathode electrode portions 50 and the joining of the anode portion 20 to the anode electrode portions 40 can be performed in a single process. As a result, the manufacturing process can be simplified compared to when the cathode portion 30 is joined to the cathode electrode portions 50, then the anode portion 20 is positioned with respect to the anode electrode portions 40, and then the anode portion 20 is joined to the anode electrode portions 40 as in the manufacturing method described in Patent Literature 1 described above. Accordingly, the man-hours required in the manufacturing process can be reduced, and the discharge tubes 1 can be put into mass production. In addition, in the discharge tube 1, since the joint regions R2 of the cathode portion 30 with the cathode electrode portions 50 do not overlap the anode portion 20 in the direction D1, the occurrence of abnormal discharge due to the joint regions R2 overlapping the anode portion 20 can be suppressed. Therefore, according to the discharge tube 1, the manufacturing process of the discharge tube can be simplified, and the detection accuracy can be improved. In addition, in the discharge tube 1, since the anode portion 20 and the cathode portion 30 are made of flat plate-shaped members, the number of processes that may involve deformation of the members can be reduced, for example, compared to when the anode portion and the cathode portion include bent portions. Therefore, the accuracy of the spacing between the anode portion 20 and the cathode portion 30 can be improved.

The joint regions R2 are formed to be thinner than portions of the cathode portion 30 that surround the joint regions R2. Accordingly, the joining of the cathode portion 30 to the cathode electrode portions 50 can be facilitated. For example, when the cathode portion 30 is joined to the cathode electrode portions 50 by laser welding, by forming the joint regions R2 to be thinner than portions of the cathode portion 30 that surround the joint regions R2, laser welding can be performed using laser light with lower output than when the joint regions R2 are not formed to be thinner. Therefore, the joining of the cathode portion 30 to the cathode electrode portions 50 can be facilitated. In addition, the joining of the anode portion 20 to the anode electrode portions 40 can be facilitated by forming the joint regions R1 to be thinner than portions of the anode portion 20 other than the joint regions R1.

The joint regions R2 are formed to be thinner than the portions surrounding the joint regions R2 by forming the recesses 32 in the cathode portion 30, the recesses 32 being open to the one side S1. In this case, for example, the recesses 32 can be used as marks, and the joining of the cathode portion 30 to the cathode electrode portions 50 can be facilitated. For example, when the cathode portion 30 is joined to the cathode electrode portions 50 by laser welding from the one side S1 of the cathode portion 30, the recesses 32 serve as marks for the welding locations, and therefore, the welding locations can be easily identified compared to when the recesses 32 are not provided. Therefore, the joining of the cathode portion 30 to the cathode electrode portions 50 can be facilitated. In addition, since the recesses 32 are formed to open to the one side S1, the joint regions R2 are spaced farther apart from the anode portion 20 in the direction D1 than the portions other than the joint regions R2. Therefore, even if deformation or the like occurs in the joint regions R2 due to joining, a reduction in the distance to the anode portion 20 in the direction D1 can be suppressed. Therefore, the possibility of discharge occurring due to the joint regions R2 can be reduced. In addition, the joint regions R1 are formed to be thinner than the portions other than the joint regions R1 by forming the recesses 22 in the anode portion 20, the recesses 22 being open to the one side S1. In this case, the recesses 22 can be used as marks, and the joining of the anode portion 20 to the anode electrode portions 40 can be facilitated.

The cathode portion 30 includes the cutout portions 33 formed in the outer edge portion 30a, and the cutout portions 33 are exposed from the anode portion 20 when viewed from the one side S1 in the direction D1. Accordingly, the occurrence of abnormal discharge due to the cutout portions 33 overlapping the anode portion 20 can be suppressed. Namely, when the cutout portions 33 overlap the anode portion 20, there is a possibility that abnormal discharge occurs between the cutout portions 33 and the anode portion 20; however, according to the cathode portion 30 in the present embodiment, the occurrence of such abnormal discharge can be suppressed. In addition, the anode portion 20 includes the cutout portions 23 formed in the outer edge portion 20a, and the cutout portions 23 are exposed from the cathode portion 30 when viewed from the other side S2 in the direction D1. Accordingly, the occurrence of abnormal discharge due to the cutout portions 23 overlapping the cathode portion 30 can be suppressed.

### MODIFICATION EXAMPLES

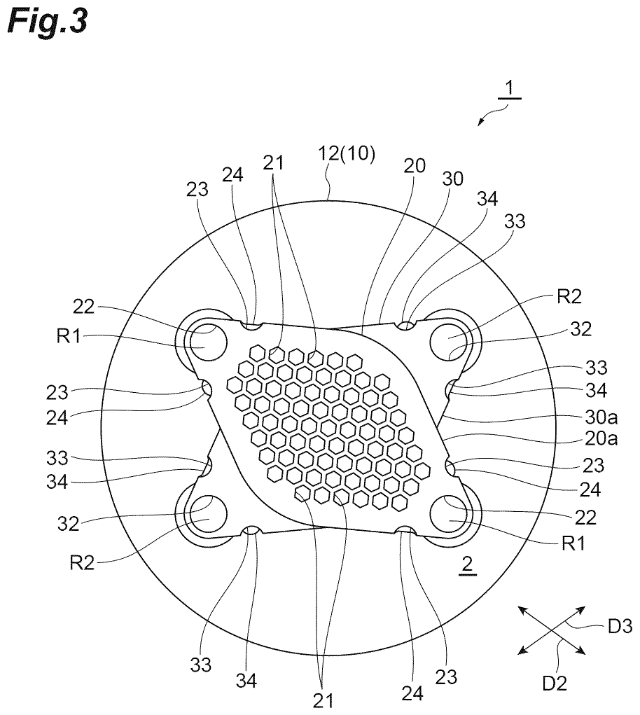

In a first modification example shown in FIG. 3, the anode portion 20 includes a protruding portion 24 protruding from an inner surface of each of the cutout portions 23. The protruding portion 24 is, for example, a burr that is generated when the anode portion 20 is cut off from a metal member during the manufacturing process of the anode portion 20, and is a part of the bridge portion described above that remains in the anode portion 20. The protruding portion 24 is located inside the cutout portion 23 when viewed in the direction D1. Namely, the protruding portion 24 is located inside the outer edge portion 20a (an outer edge when it is assumed that the cutout portion 23 is not formed) of the anode portion 20 when viewed in the direction D1.

In addition, the cathode portion 30 includes a protruding portion 34 protruding from an inner surface of each of the cutout portions 33. The protruding portion 34 is, for example, a burr that is generated when the cathode portion 30 is cut off from a metal member during the manufacturing process of the cathode portion 30, and is a part of the bridge portion described above that remains in the cathode portion 30. The protruding portion 34 is located inside the cutout portion 33 when viewed in the direction D1. Namely, the protruding portion 34 is located inside the outer edge portion 30a (an outer edge when it is assumed that the cutout portion 33 is not formed) of the cathode portion 30 when viewed in the direction D1.

In the first modification example, the protruding portion 34 is located inside the cutout portion 33 when viewed in the direction D1. Accordingly, the occurrence of abnormal discharge due to the protruding portion 34 protruding from the cutout portion 33 can be suppressed. Namely, when the protruding portion 34 is not located inside the cutout portion 33, abnormal discharge may occur between the protruding portion 34 and the anode portion 20; however, according to the first modification example, the occurrence of such abnormal discharge can be suppressed.

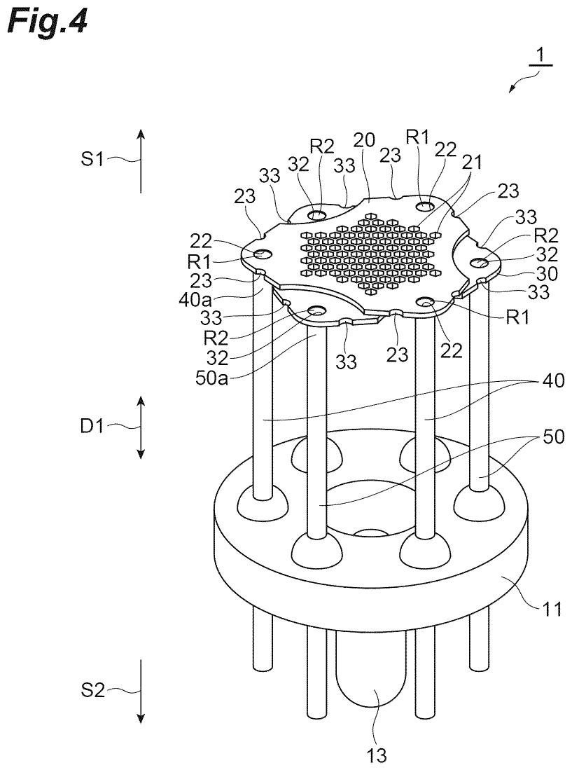

The discharge tube 1 may be configured as in a second modification example shown in FIG. 4. In FIG. 4, the glass bulb 12 is omitted. In the second modification example, the anode portion 20 and the cathode portion 30 are formed in a substantially triangular shape when viewed in the direction D1. Three anode electrode portions 40 are joined to the anode portion 20, and the anode portion 20 has three joint regions R1. In addition, the anode portion 20 includes six cutout portions 23. Similarly, three cathode electrode portions 50 are joined to the cathode portion 30, and the cathode portion 30 has three joint regions R2. In addition, the cathode portion 30 includes six cutout portions 33. In the second modification example as well, the joint regions R2 of the cathode portion 30 with the cathode electrode portions 50 are exposed from the anode portion 20 when viewed from the one side S1 in the direction A. With the second modification example as well, similarly to the above-described embodiment, the manufacturing process of the discharge tube can be simplified, and the detection accuracy can be improved.

The present disclosure is not limited to the embodiment and the modification examples described above. For example, the material and shape of each configuration are not limited to the material and shape described above, and various materials and shapes can be adopted.

In the above-described embodiment, the cathode electrode portions 50 are joined to the surface 30c on the other side S2 of the cathode portion 30; however, the cathode electrode portions 50 may be joined to the surface 30b on the one side S1 of the cathode portion 30. For example, the cathode electrode portions 50 may be disposed to penetrate through the cathode portion 30, and may be joined to the surface 30b on the one side S1 of the cathode portion 30 at portions protruding from the cathode portion 30. Namely, the cathode electrode portions 50 only need to be joined to one of the surface 30b on the one side S1 and the surface 30c on the other side S2 of the cathode portion 30. However, from the viewpoint of suppressing abnormal discharge or the like, it is preferable that the cathode electrode portions 50 are joined to the surface 30c on the other side S2 of the cathode portion 30 as in the above-described embodiment. Similarly, the anode electrode portions 40 may be joined to a surface on the one side S1 of the anode portion 20, and only need to be joined to one of the surface on the one side S1 and the surface 20b on the other side S2 of the anode portion 20. In addition, the cathode electrode portions 50 and the cathode portion 30, and the anode electrode portions 40 and the anode portion 20 are not limited to being directly joined by welding or the like, and may be connected, for example, by indirect joining using a joining material such as a brazing material.

The recesses 32 may not be formed in the cathode portion 30, and the cathode portion 30 may have the same thickness in its entirety. The recesses 22 may not be formed in the anode portion 20, and the anode portion 20 may have the same thickness in its entirety. The recesses 32 of the cathode portion 30 may be formed to open to the other side S2. The recesses 22 of the anode portion 20 may be formed to open to the other side S2. The cutout portions 33 of the cathode portion 30 may overlap the anode portion 20 when viewed from the one side S1 in the direction D1. The cutout portions 33 may not be formed in the cathode portion 30. The cutout portions 23 may not be formed in the anode portion 20. In the first modification example, the protruding portion 34 of the cathode portion 30 may include a portion that is located outside the cutout portion 33 when viewed in the direction D1. In the first modification example, the protruding portion 24 of the anode portion 20 may include a portion that is located outside the cutout portion 33 when viewed in the direction D1.

### REFERENCE SIGNS LIST

1: discharge tube, 10: container, 20: anode portion, 21: opening, 30: cathode portion, 30a: outer edge portion, 32: recess, 33: cutout portion, 34: protruding portion, 40: anode electrode portion, 50: cathode electrode portion, D1: direction (facing direction), R2: joint region.

1. A discharge tube, comprising:
a container in which a discharge gas is sealed;
an anode portion made of a plate-shaped member in which an opening is formed, and disposed in the container;
a cathode portion made of a plate-shaped member, disposed in the container to face the anode portion, and emitting photoelectrons in response to an incidence of light that has passed through the opening;
an anode electrode portion having a rod shape, extending along a facing direction in which the anode portion and the cathode portion face each other, and joined to the anode portion; and
a cathode electrode portion having a rod shape, extending along the facing direction, and joined to the cathode portion,
wherein, when a side on which the anode portion is located with respect to the cathode portion in the facing direction in which the anode portion and the cathode portion face each other is defined as one side, and a side opposite the one side is defined as the other side, the anode electrode portion extends from the anode portion to the other side, and the cathode electrode portion extends from the cathode portion to the other side, and
a joint region of the cathode portion with the cathode electrode portion is exposed from the anode portion when viewed from the one side in the facing direction.

2. The discharge tube according to claim 1,
wherein the joint region is formed to be thinner than a portion of the cathode portion, the portion surrounding the joint region.

3. The discharge tube according to claim 2,
wherein the joint region is formed to be thinner than the portion surrounding the joint region by forming a recess in the cathode portion, the recess being open to the one side.

4. The discharge tube according to claim 1,
wherein the cathode portion includes a cutout portion formed in an outer edge portion, and
the cutout portion is exposed from the anode portion when viewed from the one side in the facing direction.

5. The discharge tube according to claim 4,
wherein the cathode portion further includes a protruding portion protruding from an inner surface of the cutout portion, and
the protruding portion is located inside the cutout portion when viewed in the facing direction.
